(19) United States
(12) Patent Application Publication
(10) Pub. No.: US 2005/0045426 A1
(43) Pub. Date: Mar. 3, 2005

(54) Elevator with a scissor lift mechanism and a spring member serving as virtual counter weight

(76) Inventors: Jean-Marie Rennetaud, Fox River Valley Gardens, IL (US); Tian Zhou, Reussbuhl (CH)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 10/914,400

(22) Filed: Aug. 9, 2004

(30) Foreign Application Priority Data
Sep. 2, 2003 (EP) 03405632.5

(51) Int. Cl. B66B 9/16

(52) U.S. Cl. 187/269; 254/122; 187/211

(57) ABSTRACT

An elevator includes an elevator car supported on a scissor assembly connected to a drive mechanism. The scissor assembly has two vertical scissor columns each comprising at least one pair of arms that are pivotally movable relative to one another. The drive mechanism mechanically interacts with the scissor assembly for applying a force in order to move the elevator car upwards by unfolding the scissor assembly. At least one spring element provides a spring force which acts on at least one of the arms to provide an upwards oriented counterforce on the elevator car.

### BACKGROUND OF THE INVENTION

The present invention generally relates to elevators and, more particularly, is concerned with an elevator with a scissor lift mechanism.

In various work platform lift machines, such as scissors lifts, elevated platforms, cranes, etc., hydraulic cylinders are used to provide the necessary lifting forces. One of most popular machines of this type is called an electric slab scissor lift machine. Electric slab scissor lift machines comprise a scissor lift mechanism mounted at a lower end on a chassis, a work platform mounted on an upper end of the lift mechanism for carrying persons, and a hydraulic actuation system for operating the lift mechanism to raise and lower the work platform. The scissor lift mechanism includes a plurality of pairs of arms pivotally interconnected in a scissor-like fashion so as to raise and lower as the arms pivot between generally vertical unstacked and horizontal stacked orientations relative to one another. The hydraulic actuation system generally employs two or more hydraulic cylinders for causing pivoting of the pairs of arms to expand the lift mechanism. Typically, the hydraulic cylinders are interconnected between an adjacent pair of the arms.

The use of hydraulic actuation systems and positioning of the hydraulic cylinders in lift machines have several disadvantages, but there are other scissor mechanisms that use electro-mechanical drives for actuation.

Scissor based lifting mechanisms are well suited for elevators, in particular elevators that are designed to be employed in buildings with less than four floors. The hoistway, if needed at all, does not need to be much larger than the cross-section of the elevator platform, since all the mechanical elements as well as the actuation mechanism sits underneath the elevator platform.

It is, however, still an unsolved problem to provide a reliable approach for balancing the elevator without having to employ counterweights and ropes, or the like, that move up and down in the hoistway as the elevator platform moves down or up. Important issues when constructing scissor-based elevators are the stability, reliability, the size and price. In particular the counterweights may add substantially to the overall costs, if one considers the additional space needed in the hoistway and if one takes into account that the installation and maintenance is costly.

Some of the conventional scissor-based load elevators comprise springs interposed between the platform of the elevator and a base frame, or interposed between two of the arms of the scissor.

An example is shown in the U.S. Pat. No. 4,764,075, where two vertically aligned compression springs are employed to keep the top portion of the load always at a convenient height for better loading and unloading. In this case, said height is a function of the load. It is not possible to move a particular load to any other desired height.

Yet another example is shown in the U.S. Pat. No. 5,722,513. A scissor lift is proposed that comprises a spring assembly with several springs that can be selectively connected to vary the bias on a scissor assembly of the lift. The springs of the spring assembly are arranged in a horizontal direction. The various springs are employed to adjust the bias acting on the scissor assembly to maintain the particular load at a predetermined elevated location.

Consequently, a need exists for a different approach to balancing the scissors lift mechanism of elevators which will overcome the above-mentioned disadvantages without introducing other disadvantages in their place.

### SUMMARY OF THE INVENTION

A scissor elevator, in accordance with the present invention, includes a scissor assembly, a drive mechanism and a mounting platform. In the various embodiments described herein, the scissor elevator comprises: an elevator car; a scissor assembly carrying the elevator car, the assembly being arranged underneath the elevator car and comprising at least two vertical scissor columns, each of the scissor columns comprising at least one pair of arms which are pivotally movable relative to one another; a drive mechanism, being adapted to mechanically interact with the scissor assembly for applying a force in order to move the elevator car upwards by unfolding the scissor assembly; and at least one spring element providing a spring force which acts on at least one of the arms to provide an upwards oriented counterforce on the elevator car.

The counterforce counteracts those forces which cause the scissor assembly to fold. In particular, it counteracts the vertical load of the elevator, for example the weight of the scissor assembly, the weight of the elevator car and/or a load on the scissor assembly or a load in and/or on the elevator car. Thus, the spring element acts as a virtual counterweight reducing the force which must be provided by the drive mechanism in order to move the elevator car upwards.

The spring element can be designed such that it achieves a non-linear function of the spring force versus a distance of the elevator car with respect to the ground. In particular, said non-linear function can be chosen such that the counterforce is constant even on the condition that the distance of the elevator car with respect to the ground is changed. In particular, said non-linear function can be chosen such that the counterforce exactly cancels the vertical load of the elevator at all locations along a path of elevator car.

Inter alia, the spring element can be arranged such that a length of the spring element is varied as a function of the distance of the elevator car with respect to the ground and the spring force is varied as a function of said length, whereby the spring force is a non-linear function of said length.

The elevator, according to the present invention, has the following advantages:
Stability is provided due to the fact that two scissor columns, each comprising an integrated counterweight, are used in parallel.
Disturbing vibrations are avoided when moving the elevator car up or down.
Due to the fact that horizontal guiding means are employed, the whole system is more rigid compared to conventional approaches without guiding or with vertical guiding.
Due to the fact that horizontal guiding means are employed, that can be part of a mounting platform, the elevator can be pre-fabricated and thus installed more easily on site. This helps to drastically reduce the overall costs of the elevator.
The on-site installation is less complicated and less time consuming. No mechanical experts are needed for the installation.
The virtual counterweight, according to the present invention, is small and does not take up much room in the hoistway.
the virtual counterweight has only few moving parts and is thus less sensible to disturbances and less likely to fail;
The virtual counterweight can be pre-installed and trimmed prior to being shipped.
Due to the fact that an efficient virtual counterweight is employed, a smaller actuation mechanism can be employed to lift the elevator car, i.e. one can employ a smaller electric motor or hydraulic actuation system, for instance; thus, less power is required.
The virtual counterweight provides for increased safety of the overall system since so far uncompensated forces are substantially reduced or eliminated.

The above advantages do not necessarily apply to all the different embodiments described herein, since the embodiments are implementations of the invention with a focus on optimizing particular aspects. At the same time, however, other aspects might be less perfect.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1A is a schematic perspective representation of a first embodiment of an elevator according to the present invention;

FIG. 1B is an enlarged view of the first elevator shown in FIG. 1;

FIG. 2 is a schematic perspective representation of the lower part of a second embodiment of an elevator according to the present invention;

FIG. 3 is a diagram showing the required spring force as a function of the distance that the elevator car travels; and

FIG. 4 is a schematic perspective representation of a lower part of a third embodiment of an elevator according to the present invention.

### DESCRIPTION OF THE PREFERRED EMBODIMENT

In the following description, like reference characters designate like or corresponding parts throughout the several views of the drawings. Also in the following description, it is to be understood that such terms as “horizontal”, “vertical”, “left”, “right”, “upwards”, “downwards”, and the like are words of convenience and are not to be construed as limiting terms.

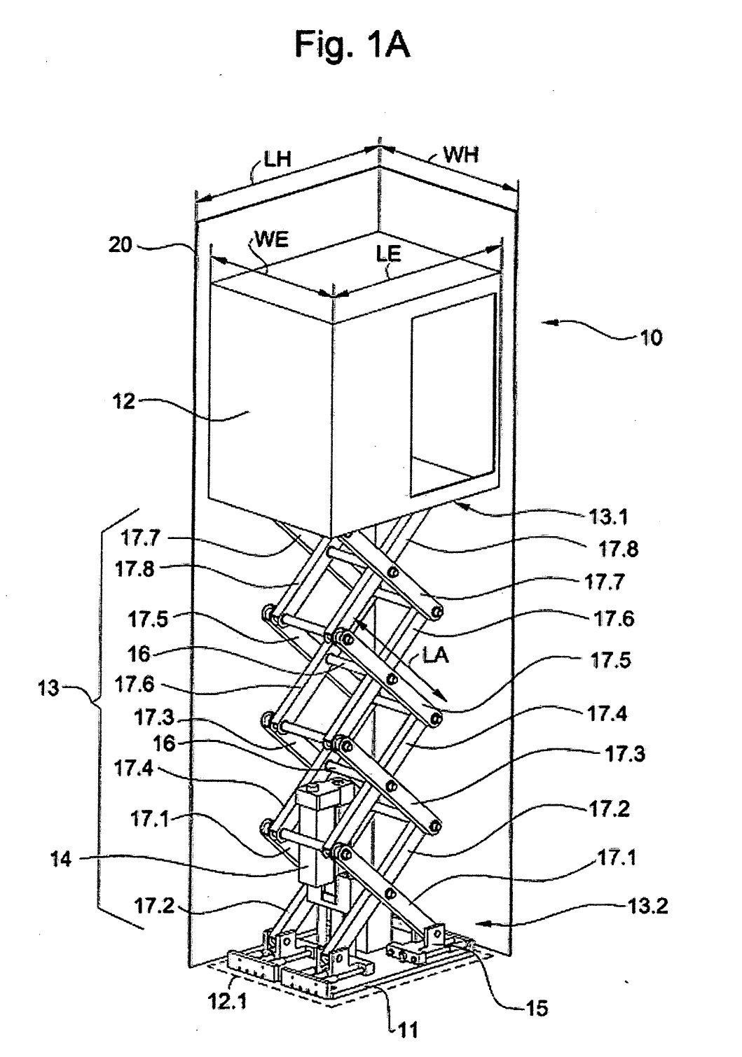

Referring to the drawings and particularly to FIGS. 1A, 1B, 2, and 3, there are illustrated various scissors-type elevators according to the present invention.

In FIGS. 1A and 1B, a first embodiment of an elevator 10 is shown. The elevator 10 is arranged in a hoistway having walls 9 and basically comprises an optional mounting platform 11, an elevator car 12, a scissor assembly 13, and an electro-mechanical drive 14. The elevator car 12 is disposed above the mounting platform 11. The scissor assembly 13 extends vertically between the mounting platform 11 and elevator car 12 and has four upper ends 13.1 (not visible in FIGS. 1A and 1B) pivotally mounting the elevator car 12 and four lower ends 13.2 horizontally mounted and guided by guiding means 15 on the mounting platform 11. The scissor assembly 13 comprises two scissor columns which preferably are substantially identical to ensure symmetry of the overall system. The two scissor columns are situated parallel to each other on either side of the elevator car 12 and are connected by at least one horizontal cross element 16. A rod or tube may serve as the cross element 16, for example. Each scissor arrangement comprises a plurality of portions or sections in the form of pairs of arms 17.1 and 17.2, 17.3 and 17.4, 17.5 and 17.6, and 17.7 and 17.8 being pivotally interconnected in a scissors-like fashion and movable relative to one another between expanded (unfolded) and retracted (folded) conditions so as to move the elevator car 12 between raised and lowered positions relative to the mounting platform 11.

Each pair of arms of the scissor assembly 13 comprises two longitudinal arms. The lower most pair of arms comprises the two arms 17.1, 17.2, for example. The arms 17.x, where “x” is an integer number, may have a solid or hollow tubular construction and they may have a substantially rectangular, circular, triangular or oval cross-section. Although, the arms 17.x may have any other suitable configuration. A length LA of each of the arms 17.x is smaller than a respective length (side-to-side) LE of the elevator car 12 if the scissor assembly 13 is to stay within a projection 12.1 of the elevator car 12. In this case, a length (side-to-side) LH and width (front-to-back) WH of the optional hoistway 20 is only slightly larger than the length LE and a width (front-to-back) WE respectively of the elevator car 12. It is, however, also possible to employ arms 17.x having the length LA that is greater than the length LE of the elevator car 12.

Each of the arms, e.g. the arm 17.3, has a pair of opposite ends 17A, 17B, as illustrated in FIG. 1B, and is disposed in substantially parallel relation to the other respective arm 17.4 of the pair. The scissor assembly 13 also includes a plurality of intersection points 17C and cross elements 16 horizontally extending between and pivotally connected respectively with corresponding ones of the arms 17.x at the intersection points 17C. The arm 17.3 is at its respective end 17B pivotally connected to the end 17A of the next arm 17.6, and so forth. Furthermore, there are optional cross elements 18 horizontally extending and pivotally connected respectively between corresponding ones of the arms 17.x of the two parallel scissor columns. The cross elements 18 may be connected to the arms 17.x at or close to the respective ends 17A, 17B.

The elevator car 12 is of any suitable type such as the one shown in FIG. 1A and FIG. 1B. An underside 12.3 of the elevator car 12 is mounted to the uppermost pairs of arms 17.7, 17.8 in a fashion that may be substantially similar to the mounting of the lowermost pairs of arms 17.1, 17.2 to the guiding means 15. The mounting is done in a way that the respective uppermost pairs of arms 17.7, 17.8 and the lowermost pairs of arms 17.1, 17.2 can move in a horizontal direction “X” relative to the elevator car 12 and the mounting platform 11 so as to allow for the expansion and retraction of the scissor assembly 13.

The guiding means 15 ensure that the four lower ends of the two lowermost pairs of arms are kept at a certain height HX above ground. In the present embodiment, the height HX is fixed. It is, however, possible to define a range Hmin to Hmax in which the lower ends of the arms are allowed to move.

In FIG. 1B, details of the guiding means 15 are shown. Each of the lower ends of the four arms 17.1, 17.2 is mounted and guided in the respective guiding means 15. The lower end 17A of the arm 17.1, for example, is pivotally connected to a horizontal slide 15.1. The arm 17.1 may be connected to the horizontal slide 15.1 by means of a pin 15.2, axle or screw, for example. Each of the guiding means 15, according to the present embodiment, comprises a central non-threaded shaft 15.3 which is arranged parallel to the ground or parallel to the mounting platform 11 and parallel to the X-axis. The horizontal slide 15.1 comprises a through hole and the shaft 15.3 extends through this hole. In the present embodiment, there are four guiding means 15 situated on the mounting platform 11. The horizontal slides 15.1 can move parallel to the X-axis along the shafts 15.3. According to the present invention, the guiding means 15 comprise at least one spring element 15.4 (e.g. a compression spring) providing a spring force which acts on the lower ends of the arms to provide an upwards oriented counterforce on the elevator car. According to the present embodiment, the spring element is arranged co-axially with the central shaft 15.3. A spring may be wound around the shaft, or a spring may be integrated into the shaft 15.3.

The spring element 15.4 is biased and arranged such that the length of the spring element is varied as a function of the distance of the elevator car 12 with respect to the mounting platform 11 and the spring force is varied as a function of said length.

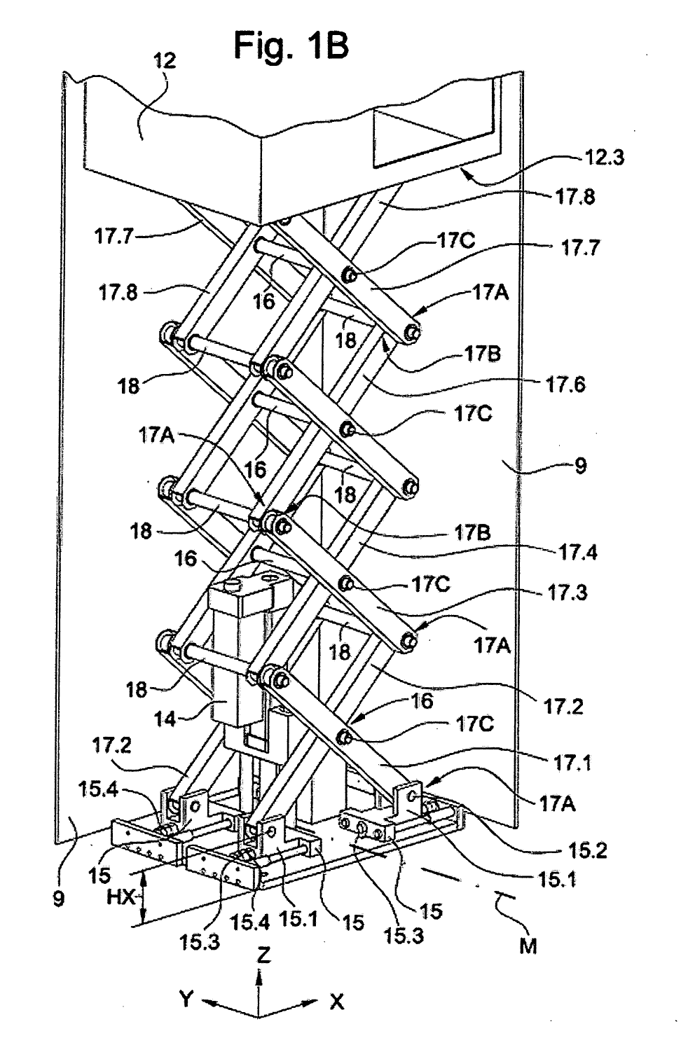

For improved symmetry, there may be one spring element on the left hand side of the central shaft 15.3 and one spring element on the right hand side thereof, as described in connection with the embodiment illustrated in FIG. 2.

The drive mechanism 14 is connected with a middle section of the lowest cross element 16 that connects the lowest pairs of arms of the scissor assembly 13. By means of the drive mechanism 14, a force can be applied on said cross element 16 in the vertical direction. Thus, the drive mechanism 14 is adapted to mechanically interact with the scissor assembly 13 for applying a force in the vertical direction in order to move the elevator car 12 upwards by unfolding the scissor assembly 13. The drive 14 can include a brake for holding the scissor assembly 13 at any selected vertical position and for damping downward movement.

The spring elements 15.4 are arranged so that they interact with the sliding element 15.1 to bias it towards an unfolded position of the elevator. Preferably, the spring element is guided by a horizontal shaft (e.g. the central shaft 15.3) or the like.

The spring elements 15.4 bias the four horizontal slides 15.1 on the platform 11 towards a centerline or middle M. Therefore, the spring elements 15.4 counteract the vertical load of the elevator 10. Thus, the spring elements 15.4 have to some extent the same function as a counterweight in a conventional elevator. The force to be provided by the drive mechanism 14 in order to move the elevator car upwards is reduced by the extent that the vertical load of the scissor elevator is compensated for by the spring forces of the spring elements 15.4. For this reason, the spring elements 15.4 are herein referred to as virtual counterweight.

As stated above, the mounting platform 11 is optional. The scissor assembly 13, the drive 14 and the guiding means 15 can be mounted on any suitable support surface such as the platform 11 or the ground (e.g. a building floor).

Another embodiment of an elevator according to the present invention is illustrated in FIG. 2 that is an enlarged perspective view of just the lower portion of an elevator 20. The elevator 20 comprises a mounting platform 21 fixed on a support surface such as an essentially flat ground 22. There are again four guiding means 25 situated on the mounting platform 21, as are the guiding means 15 in FIGS. 1A and 1B. Each of the four guiding means 25 mounts and guides one of lower arms 27.1 and 27.2 of a scissor assembly which comprises two vertical scissor columns. Each guiding means 25 comprises a horizontal slide 25.1 with a central through hole 25.4. Central shafts 25.3 extend through these holes 25.4. The elevator 20 comprises a drive mechanism (not shown in FIG. 2) being adapted to mechanically interact with the scissor assembly for applying a force in the vertical direction in order to unfold the scissor assembly. The guiding means 25 further comprise spring elements 25.5 that consist of two cylindrical spring members 25.51 and 25.52 being disposed in series. The spring members 25.51 and 25.52 might be horizontally guided in an X-direction. The spring elements 25.5 bias the two horizontal slides 25.1 on the right hand side of the platform 21 towards the left and the two horizontal slides 25.1 on the left hand side of the platform 21 to the right. Therefore, the spring elements 25.5 counteract the vertical load of the elevator 20. Thus, the spring elements 25.5 have to some extent the same function as a counterweight in a conventional elevator.

In the present example, the spring members 25.51 and 25.52 are situated between an edge 26 of the mounting platform 21 and a vertical part 25.6 of the sliding element 25.1.

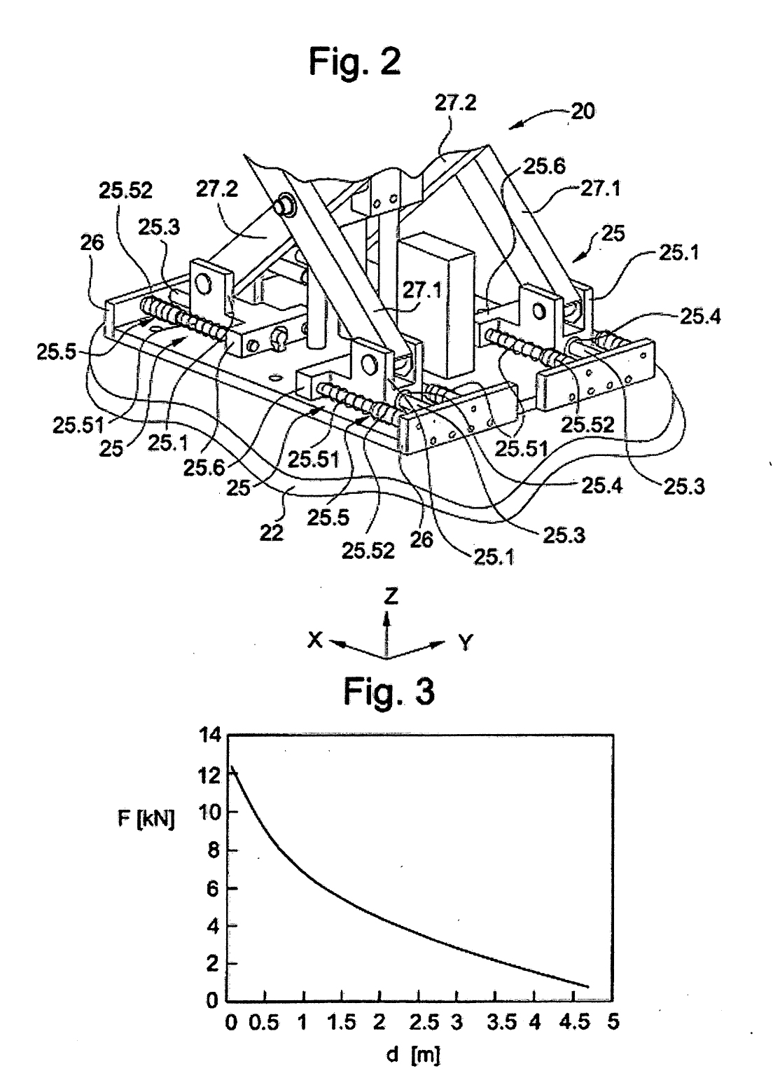

In order to provide for a virtual counterweight that behaves like a conventional counterweight moving up and down in a hoistway, it is advantageous to employ a spring element having a non-linear characteristic. As illustrated in FIG. 3, the distance that the elevator car travels requires a non-linear spring force to ensure that the virtual counterweight behaves like a real counterweight, independent of the travel distance of the elevator car above ground. FIG. 3 shows—for a particular elevator—a force “F” (horizontally acting on the lower ends of the arms 27.1 and 27.2) that need to be provided by a spring element in order to cancel exactly the vertical load of the elevator as a function of a distance “d” between the elevator car with respect to the lowest position which can be taken by the elevator car when the scissor assembly is completely retracted. As it is shown in FIG. 3, the force “F” non-linearly decreases as a function of “d”.

In the case of the embodiment in accordance with FIG. 2, the non-linear characteristic of FIG. 3 can be approximated by using spring members 25.51 and 25.52 with different spring rates. In this way, the non-linear curve of FIG. 3 is approximated by two adjacent linear sections, said sections having different slopes as a function of “d”.

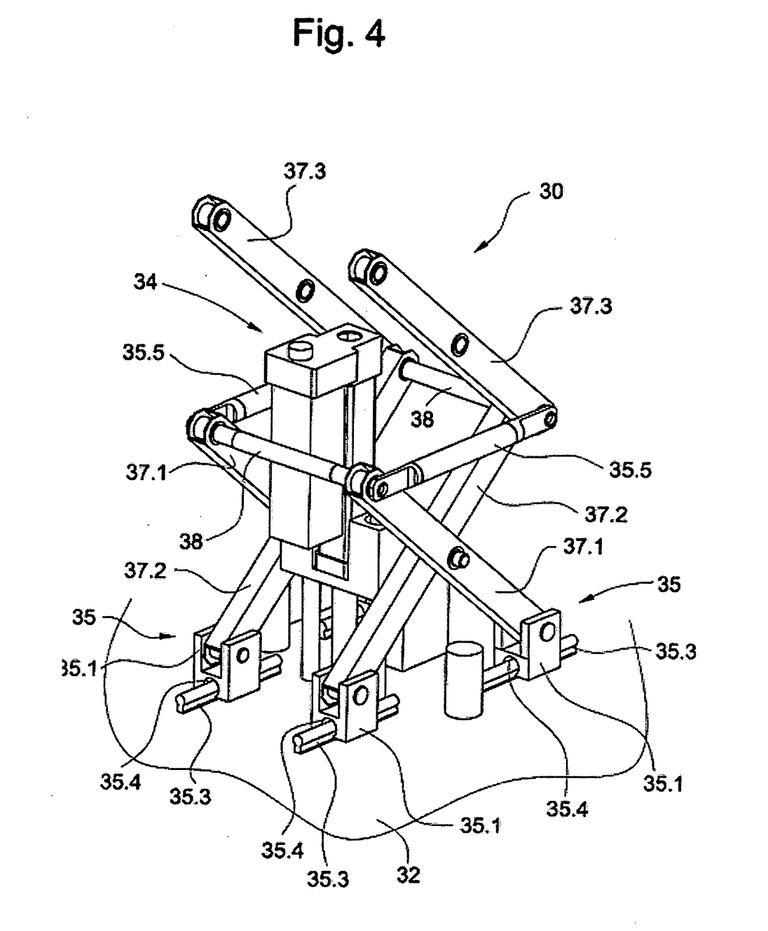

Yet another embodiment is illustrated in FIG. 4 that is an enlarged perspective view of a part of the lower portion of a third embodiment elevator 30 according to the present invention. The elevator 30 does not include a mounting platform 11 or 21, as in the other embodiments. All elements are located on an essentially flat ground 32 such as a building floor. Just two pairs of arms 37.1, 37.2 of a scissor assembly are depicted in FIG. 4. A drive mechanism 34 is adapted to mechanically interact with the scissor assembly for applying a force in the vertical direction in order to unfold the scissor assembly. The drive 34 can include a brake for holding the scissor assembly at any selected vertical position and for damping downward movement.

The lower ends of the arms 37.1, 37.2 are mounted in a guiding means 35. These guiding means 35 are fixed on the ground 32 by means of screws or the like. The guiding means 35 mount and guide the lower arms 37.1 and 37.2. Each of the guiding means 35 comprises a horizontal slide 35.1 with a central through hole 35.4. Central shafts or rails 35.3 extend through these holes 35.4 and are fixed to the ground 32 such that the slides 35.1 are slidable along the rails. Cylindrical spring members or elements 35.5 (tension springs) are arranged between the upper ends of the arms 37.1, 37.2 of each of the lowest pairs of arms, as illustrated in FIG. 4. Each end of a particular spring member 35.5 is connected to one of a pair of axles 38 that connect the upper ends of the respective arms 37.1 and 37.2 of the lowest pairs of arms. The spring members 35.5 apply a force that tries to reduce the distance between the two horizontal slides 35.1 of each of the lowest pairs of arms. The spring members 35.5 have a non-linear characteristic in order to apply a tractive force that gets smaller the higher the elevator car rises. When the scissor assembly returns to the folded position, i.e., when the elevator car moves downwards, the tractive force increases. Therefore, the spring members 35.5 counteract the vertical load of the elevator 30. Thus, the spring members 35.5 have to some extent the same function as a counterweight in a conventional elevator.

Other embodiments are conceivable where the spring members are arranged in a different manner. It is for example possible to combine the spring members of FIG. 2 and the spring members of FIG. 4 in one embodiment. In each of the embodiments, the scissor assembly 13 is mounted on a support apparatus providing a support surface. In FIGS. 1A and 1B, the support apparatus includes the mounting platform 11 (the support surface) and the guiding means 15. In FIG. 2, the support apparatus includes the mounting platform 21 (the support surface) and the guiding means 25. In FIG. 4, the support apparatus includes the ground 32 (the support surface) and the guiding means 35.

Due to the fact that the scissor assembly 13 is employed, a small upwards movement of the lower most arms 17.1, 17.2 caused by the drive 14 is translated into a larger vertical movement of the elevator car 12. The maximum movement of the drive 14 corresponds to the maximum expansion of the overall scissor assembly 13. According to the present invention, an electro-mechanical or a hydraulic actuation system can be used to unfold the scissor assembly. The actuation mechanism has to be arranged such that the symmetry of the system is maintained.

The springs, as used in the embodiments described above, can be pre-loaded when fitting them.

In a preferred embodiment, the springs are designed to balance the whole elevator system at least in those positions (travel distance above ground) where the landing levels are. The springs can be specially developed to provide the required spring characteristics.

The virtual counterweight, according to the present invention, allows one to counterbalance the load.

Due to the fact that the spring elements are horizontally arranged at or close to the mounting platform, the accident hazard is reduced when persons perform installation or maintenance work at or close to the scissor assembly.

According to the present invention, a virtual counterweight is provided that allows one to offset the mass of the scissor assembly and/or the mass of the elevator car and/or the mass of the load in and/or on the car.

According to another embodiment of the present invention, a rail 35.3 is employed for guiding the sliding element 35.1 of the guiding means, the rail being horizontally oriented.

According to a preferred embodiment of the present invention, the spring element provides a non-linear function of the spring force versus travel distance of the elevator car. The spring element can be arranged such that a length of the spring element is varied as a function of the distance of the elevator car with respect to the ground and the spring force is varied as a function of said length, whereby the spring force is a non-linear function of the length of the spring element. The spring element may either comprise one spring having a non-linear characteristic, or at least two springs being arranged and coupled to approximate the non-linear function. The spring element may comprise a polymer, or an elastomer or polyurethane (PU) material, for example.

In yet another embodiment, the mounting platform comprises damping elements acting on the lower ends of the arms.

Each spring element may be designed such that the counterforce being induced by the spring element is sufficient to compensate the weight of the scissor assembly and the weight of the elevator car.

In a different approach, each spring element may be designed such that the counterforce being induced by the spring element is sufficient to (fully or at least partially) compensate—besides the weight of the scissor assembly and the weight of the elevator car—a load in and/or on the elevator car in addition.

During operation of the elevator, the load in and/or on the elevator car might be changed. Thus, the latter approach can be refined by providing means for measuring the weight of the load and means for adapting the spring force as a function of a signal provided by said means for measuring the weight of the load. For adapting the spring force, several approaches can be applied. For example, the elevator might comprise means that adapt the bias of the spring element as a function of the weight of the load. As an alternative, each spring element may consist of a plurality of biased spring members, whereby each of said spring members can be either engaged to or disengaged from the respective arms of the scissor assembly on demand. Thus, the counterforce being induced by the spring element can be adapted by changing the number of spring elements being engaged with a particular arm in dependence on the measured weight of the load.

In accordance with the provisions of the patent statutes, the present invention has been described in what is considered to represent its preferred embodiment. However, it should be noted that the invention can be practiced otherwise than as specifically illustrated and described without departing from its spirit or scope.

1. An elevator support apparatus for mounting an elevator carried by a scissor assembly, the scissor assembly having two vertical scissor columns, each of the scissor columns including at least one pair of arms that are pivotally movable relative to one another, and a drive mechanism mechanically interacting with the scissor assembly for applying a force to move the elevator car upwards by unfolding the scissor assembly, comprising:
a support surface;
a guiding means mounted on said support surface and adapted to slidably connect the scissor assembly to said support surface; and
at least one spring element connected to said guiding means for providing a spring force to act on the scissor assembly to provide an upwards oriented counterforce on the elevator car.

2. The support apparatus according to claim 1 wherein said support surface is one of a mounting platform and ground.

3. The support apparatus according to claim 1 wherein said guiding means permit the scissor assembly to fold and unfold.

4. The support apparatus according to claim 1 wherein said guiding means includes a plurality of slides slidably mounted on said support surface and each adapted to attach to and horizontally guide a lower end of an arm of two lowest pairs of arms of the scissor assembly.

5. The support apparatus according to claim 4 wherein guiding means further includes one of a rail and a shaft for guiding an associated one of said slides, each said one of a rail and a shaft being horizontally oriented.

6. The support apparatus according to claim 1 wherein said at least one spring element urges said guiding means toward an unfolded position of the scissor assembly.

7. The support apparatus according to claim 1 wherein said at least one spring element is guided by a horizontal shaft.

8. The support apparatus according to claim 1 wherein said at least one spring element is varied in length as a function of a distance of the elevator car with respect to said support surface and said spring force is varied as a function of said length.

9. The support apparatus according to claim 8 wherein said at least one spring element provides said spring force as a non-linear function of the distance of the elevator car with respect to said support surface.

10. The support apparatus according to claim 8 wherein said spring force is a non-linear function of said length of said at least one spring element.

11. The support apparatus according to claim 1 wherein said at least one spring element is one of a single spring having a non-linear force characteristic and at least two springs being arranged and coupled to provide the non-linear force characteristic.

12. The support apparatus according to claim 1 wherein said at least one spring element is formed of one of a polymer, an elastomer and a polyurethane material.

13. An elevator comprising:
an elevator car;
a scissor assembly carrying said elevator car and extending between a support apparatus and an underneath of said elevator car, said scissor assembly including a pair of vertically extending scissor columns, each of said scissor columns having at least two pairs of arms which are pivotally movable relative to one another;
a drive mechanism mechanically interacting with said scissor assembly for applying a force to move said elevator car upwards by unfolding said scissor assembly; and
at least one spring element connected to said scissor assembly for providing a spring force acting on at least one of said arms to apply an upwards oriented counterforce on said elevator car.

14. The elevator according to claim 13 wherein said at least one spring element generates said counterforce with a magnitude to at least partially compensate for a force being oriented downwardly on said scissor assembly.

15. The elevator according to claim 14 wherein said drive mechanism includes a brake for at least one of holding said elevator car at a selected vertical position level and damping downward movements of said elevator car.

16. The elevator according to claim 14 further comprising guiding means attached to and horizontally guiding lower ends of said arms of lowest pairs of said arms of said scissor assembly.

17. The elevator according to claim 14 further comprising a mounting platform adapted to be situated on a ground surface, said mounting platform carrying at least one of said drive mechanism and said scissor assembly.

18. The elevator according to claim 14 wherein said at least one spring element is arranged horizontally.

19. The elevator according to claim 14 wherein said at least one spring element is varied in length as a function of a distance of the elevator car with respect to said support surface and said spring force is varied as a function of said length.

20. The elevator according to claim 14 wherein said at least one spring element provides said spring force as a non-linear function of the distance of the elevator car with respect to said support surface.

21. The elevator according to claim 14 wherein said spring force is a non-linear function of said length of said at least one spring element.

22. The elevator according to claim 14 wherein said at least one spring element is one of a single spring having a non-linear force characteristic and at least two springs being arranged and coupled to provide the non-linear force characteristic.

23. The elevator according to claim 14 wherein said at least one spring element is formed of one of a polymer, an elastomer and a polyurethane material.

24. The elevator according to claims 14 wherein said at least one spring element functions as a virtual counterweight for said elevator car.

25. The elevator according to claim 14 wherein said counterforce is sufficient to compensate for at least one of a weight of said scissor assembly, a weight of said elevator car and a load carried by said elevator car.
